(19) United States
(12) Patent Application Publication
(10) Pub. No.: US 2009/0008891 A1
(43) Pub. Date: Jan. 8, 2009

(54) LOWER ARM OF VEHICLE SUSPENSION

(76) Inventors: Chanwoo Jang, Bucheon-si (KR); Daewoo Jung, Seongnam-si (KR)

Correspondence Address: MORGAN, LEWIS & BOCKIUS LLP (SF), One Market, Spear Street Tower, Suite 2800, San Francisco, CA, 94105, US

(21) Appl. No.: 11/943,011

(22) Filed: Nov. 20, 2007

(30) Foreign Application Priority Data
Jul. 3, 2007 (KR) 10-2007-0066323

(51) Int. Cl. B60G 3/04

(52) U.S. Cl. 280/124.134

(57) ABSTRACT

A lower arm of a vehicle suspension includes a base defining: a knuckle assembly configured for a knuckle and ball joints to be coupled thereto, a front assembly configured to be coupled to a front side of a vehicle body, and a rear assembly configured to be coupled to a rear side of the vehicle body. The knuckle assembly, the front assembly, and the rear assembly define a plane. The front assembly includes a pipe member coupled to the base. A first cross-section of the base is defined by a first center part that curves below the plane defined by the assemblies, a first wall portion extending downward from the first center part, and an end portion extending inward from the first wall portion.

### CROSS-REFERENCE TO RELATED APPLICATIONS

The present application is based on, and claims priority from, Korean Application Serial Number 10-2007-0066323, filed on Jul. 3, 2007, the disclosure of which is hereby incorporated by reference herein in its entirety.

### FIELD OF THE INVENTION

The present invention relates to a lower arm of a vehicle suspension.

### BACKGROUND OF THE INVENTION

In general, a lower arm connects a sub-frame and an axle to each other to form a suspension. The lower arm restricts movement applied by the tires in lateral, longitudinal, and vertical directions.

During vehicle collisions, the lower arm often buckles, absorbing collision energy to prevent damage to the axle, the sub-frame, and the like.

A typical lower arm has a hollow square cross-section and includes a separate reinforcement member to ensure sufficient strength. In recent years, single-plate lower arms have been developed in order to reduce weight and manufacturing costs.

A single-plate lower arm should have a simple, light weight structure and provide manufacturing advantages. In addition, the single-plate lower arm needs to have strength and durability equal to or greater than the square lower arm.

### SUMMARY OF THE INVENTION

A lower arm of a vehicle suspension includes a base defining: a knuckle assembly configured for a knuckle and ball joints to be coupled thereto, a front assembly configured to be coupled to a front side of a vehicle body, and a rear assembly configured to be coupled to a rear side of the vehicle body. The knuckle assembly, the front assembly, and the rear assembly define a plane. The front assembly includes a pipe member coupled to the base. A first cross-section of the base is defined by a first center part that curves below the plane defined by the assemblies, a first wall portion extending downward from the first center part, and an end portion extending inward from the first wall portion.

A second cross-section of the base, near the knuckle assembly, is defined by a second center part that curves below the plane defined by the assemblies, and a second wall portion extending downward from the second center part. A third cross-section of the base, near the rear assembly, is defined by a third center part that curves below the plane defined by the assemblies, and a third wall portion extending downward from the third center part.

The base may also include ribs extending upward from the base to the knuckle assembly such that the ribs surround at least a portion of an assembly hole of the knuckle assembly.

A weight reducing hole may also be provided in the base.

### BRIEF DESCRIPTION OF THE DRAWINGS

For a better understanding of the nature and objects of the present invention, reference should be made to the following detailed description with the accompanying drawings, in which:

FIG. 1 is a perspective view showing a lower arm of a vehicle suspension according to an embodiment of the invention;

FIG. 2 is a cross-sectional view of portion II of FIG. 1;

FIG. 3 is a cross-sectional view of portion III of FIG. 1; and

FIG. 4 is an enlarged view of portion IV of FIG. 1.

### DETAILED DESCRIPTION OF THE PREFERRED EMBODIMENTS

Referring to the FIGS, a lower arm 1 according to an embodiment of the invention includes a knuckle assembly 3, a front assembly 5, and a rear assembly 7 that form a triangle. A knuckle and ball joints are coupled to knuckle assembly 3. Front assembly 5 is coupled to a front side of a vehicle body. Rear assembly 7 is coupled to a rear side of the vehicle body. Knuckle assembly 3, front assembly 5, and rear assembly 7 are connected to each other by a base 9 that is located at a generally central position of the triangle formed by knuckle assembly 3, front assembly 5, and rear assembly 7.

Knuckle assembly 3, rear assembly 7, and base 9 may be integrally formed as a single plate. A pipe member 11, that passes through the vehicle body in a longitudinal direction, is coupled to base 9, thereby forming front assembly 5.

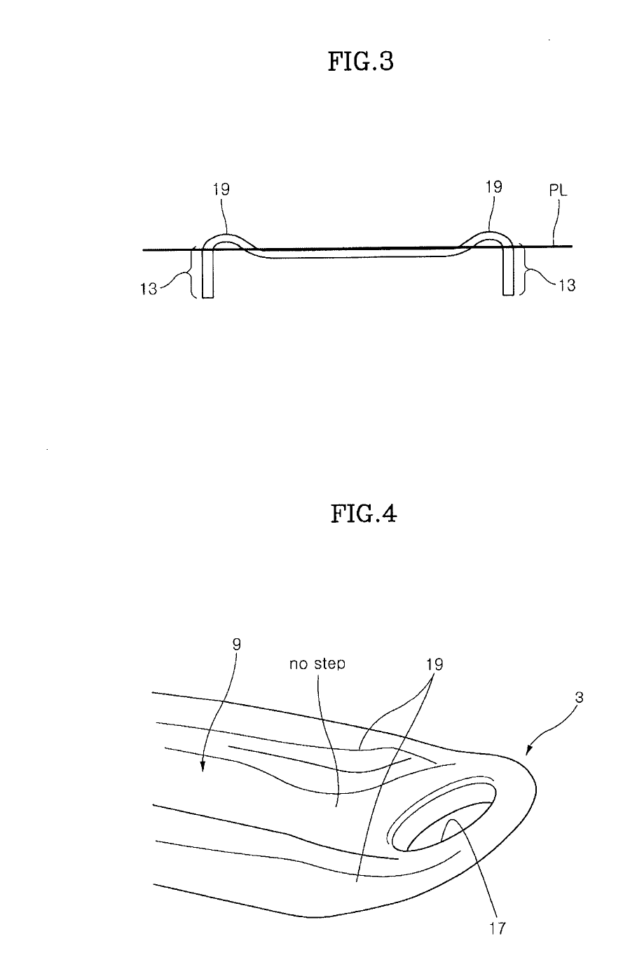

An upper surface of a center part of base 9 curves below a load engaging surface PL (FIGS. 2-3), to form a U-shaped cross-section. The load engaging surface PL is the plane formed by knuckle assembly 3, front assembly 5, and rear assembly 7. The edge of base 9 includes a vertical wall portion 13 that extends down from the upper surface of base 9, and end portions 15 that extend inward from vertical wall portion 13.

Since base 9 has the above-described cross-section, the shear center of base 9 is close to the center of lower arm 1, and thus a relatively small torsional moment is applied to lower arm 1. Therefore, torsional rigidity of lower arm 1 is not compromised.

Meanwhile, in portions III, as shown in FIG. 3, the lower part of vertical wall portion 13 forms an end portion of base 9. That is, in portions III, base 9 does not include separate end portions 15, allowing a simple manufacturing process and reduced weight.

As shown in FIG. 4, an upper surface of knuckle assembly 3 is connected to the center part of base 9 to form one smooth curve without any stepped, uneven, or irregular portions therebetween. A ball joint is mounted on the upper surface of knuckle assembly 3.

Further, ribs 19 that protrude upward from base 9 to knuckle assembly 3 may be provided near the junction between base 9 and knuckle assembly 3. Ribs 19 surround at least a portion of an assembly hole 17 in knuckle assembly 3. Therefore, rigidity of knuckle assembly 3 is sufficient.

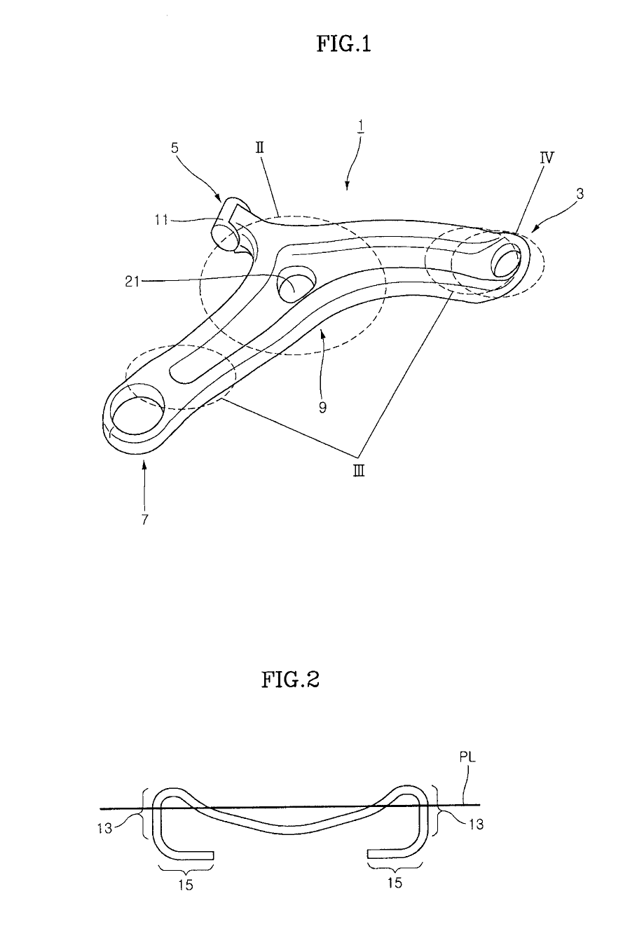

Referring back to FIG. 1, one or more weight reducing holes 21 may be provided in base 9, and burrs of the weight reducing holes 21 may face downward. Therefore, the weight of lower arm 1 is minimized while maintaining structural rigidity of lower arm 1.

Although the preferred embodiments of the present invention have been disclosed for illustrative purposes, those skilled in the art will appreciate that various modifications, additions and substitutions are possible, without departing from the scope and spirit of the invention as set forth in the accompanying claims.

What is claimed is:

1. A lower arm of a vehicle suspension, comprising:
a base defining: a knuckle assembly configured for a knuckle and ball joints to be coupled thereto, a front assembly configured to be coupled to a front side of a vehicle body, and a rear assembly configured to be coupled to a rear side of the vehicle body, wherein the knuckle assembly, the front assembly, and the rear assembly define a plane;
wherein the front assembly comprises a pipe member coupled to the base;
and wherein a first cross-section of the base comprises:
a first center part that curves below the plane defined by the assemblies;
a first wall portion extending downward from the first center part; and
an end portion extending inward from the first wall portion.

2. The lower arm as set forth in claim 1,
wherein a second cross-section of the base, near the knuckle assembly, comprises: a second center part that curves below the plane defined by the assemblies, and a second wall portion extending downward from the second center part;
and wherein a third cross-section of the base, near the rear assembly, comprises: a third center part that curves below the plane defined by the assemblies, and a third wall portion extending downward from the third center part.

3. The lower arm as set forth in claim 1, wherein the knuckle assembly comprises an assembly hole, and wherein the base further comprises ribs extending upward from the base to the knuckle assembly such that the ribs surround at least a portion of the assembly hole.

4. The lower arm as set forth in claim 1, wherein the base further comprises a weight reducing hole.
